(19) United States
(12) Patent Application Publication
(10) Pub. No.: US 2007/0020432 A1
(43) Pub. Date: Jan. 25, 2007

(54) Disposable mat, a container comprising a disposable mat, and a method of promoting the sale of a disposble mat

(75) Inventors: Dana Paul Gruenbacher, Fairfield, OH (US); Elizabeth Ann Rohrbaugh, Hamilton, OH (US); Douglas Charles Matthews, Hamilton, OH (US); Barry Robert Prather, Cincinnati, OH (US); Sonia Rahman, Loveland, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/490,831

(22) Filed: Jul. 21, 2006

Related U.S. Application Data
(60) Provisional application No. 60/701,448, filed on Jul. 21, 2005.

(51) Int. Cl. B32B 3/10

(52) U.S. Cl. 428/136; 428/40.1; 428/182

(57) ABSTRACT

The present invention relates to a disposable mat comprising at least two removable layers in a stacked configuration and a support sheet, said at least two removable layers being attached to said support sheet adjacent to at least a portion of the perimeter edge of said support sheet, said support sheet providing stiffness, non-slip and cushioning to said at least two removable layers, characterized in that said support sheet comprises a foam having a density of from 0.005 g/cm³ to 0.5 g/cm³. The present invention also relates to a container comprising at least one disposable mat, rolled-up in a cylindrical configuration, and to a method of promoting the sale of a disposable mat.

### CROSS REFERENCE TO RELATED APPLICATION

This application claims the benefit of U.S. Provisional Application No. 60/701448, filed on Jul. 21, 2005.

### FIELD OF THE INVENTION

The present invention relates to a disposable mat, a container comprising said mat, and a method of promoting the sale of said disposable mat.

### BACKGROUND OF THE INVENTION

Disposable mats are well known in the art. One type of a disposable mat is a mat with a single sheet, which needs to be replaced once it no longer picks up any further soil. Such mats need to be replaced often.

In order to extend the life of disposable mats, disposable mats comprising a stack of sheets have been developed. Once a sheet becomes dirty, it can be peeled off or removed from the mat. One problem with this type of mat however is that the various sheets tend to slip or slide over one another when a person cleans the sole of his shoes, leading to wrinkling of the mat and unsafe usage conditions.

In order to overcome this problem, the prior art teaches the addition of an adhesive between the sheets, such that the various sheets stick to each other and can no longer slip. This however leads to another drawback, namely that once the dirty sheet has been removed, the upper surface of the fresh sheet is coated with adhesive and thus leaves the surface sticky or tacky. While that in itself may provide some cleaning benefits (as the dirt on the soles of shoes would actually stick to the adhesive), this still leads to negatives with respect to usage convenience and safety. Indeed, the user's shoes would stick to the sheet, so that it would be difficult to release the mat when one tries to step off the mat.

As an alternative, the prior art provides for disposable mats which are to be placed on a separate base, and the stack of sheets can be secured by mechanical means located on the base. However, the base is not disposable and as it becomes dirty through use, the base would therefore need to be replaced. As such, the use of disposable mats in combination with a non-disposable base does not provide much more convenience versus permanent mats.

Another problem with disposable mats is that they are typically not packaged, being generally displayed for sale in a flat configuration, stacked upon each other. As mats have rather large dimensions, it is difficult to display such mats on shelves as they occupy a lot of shelf space, nor is it attractive to display mats for sale like this. It is also inconvenient for a consumer to transport the mat from a shop to his home.

The present invention overcomes these problems.

It is therefore one objective of the present invention to provide a disposable mat comprising a stack of removable sheets, wherein the removable sheets do not slip or slide when a person cleans his shoes.

It is another objective of the present invention to provide a disposable mat comprising a stack of removable sheets, wherein the removable sheets do not wrinkle upon use.

It is another objective of the present invention to provide a disposable mat comprising a stack of removable sheets, which is convenient and safe in use.

It is another objective of the present invention to provide a disposable mat comprising a stack of removable sheets, which provides improved cleaning benefits.

It is yet another objective of the present invention to provide a disposable mat comprising a stack of removable sheets, wherein the removable sheets are strongly bonded to each other, yet easy to be peeled off.

It is yet another objective of the present invention to provide a disposable mat comprising a stack of removable sheets, which can be easily rolled-up and packaged in a container having relatively small dimensions.

It is yet another objective of the present invention to provide a disposable mat which is aesthetically attractive.

### SUMMARY OF THE INVENTION

According to a first aspect, the present invention relates to a disposable mat 10 comprising at least two removable sheets 20 in a stacked configuration and a support sheet 40, said at least two removable sheets 20 being attached to said support sheet 40 adjacent to at least a portion of the perimeter edge 35 of said support sheet 40, said support sheet 40 providing stiffness, non-slip and cushioning to said at least two removable sheets 20, characterized in that said support sheet 40 comprises a foam having a density of from 0.005 g/cm³ to 0.5 g/cm³.

According to a second aspect, the present invention relates to a container 50 comprising at least one disposable mat 10, rolled-up in a cylindrical configuration.

According to a third aspect, the present invention relates to a method of promoting the sale of a disposable mat 10, comprising the step of displaying a container 50 comprising said disposable mat 10, rolled-up in a cylindrical configuration.

### BRIEF DESCRIPTION OF THE DRAWINGS

FIG. 1 shows a side view of a disposable mat according to the present invention.

FIG. 2 shows a top view of a disposable mat according to the present invention.

FIG. 3 shows a side view of a preferred removable sheet of the disposable mat according to the present invention.

FIG. 4 shows a side view of a preferred support sheet of the disposable mat according to the present invention.

FIG. 5 shows a perspective view of a disposable mat according to the present invention, rolled-up in a cylindrical configuration.

FIG. 6 shows a perspective view of a container according to the present invention.

FIG. 7a shows a front view of containers according to the present invention, displayed on a shelf.

FIG. 7b shows a front view of containers according to the present invention, displayed in another way on a shelf.

FIG. 8 shows a side view of a preferred embodiment of the disposable mat according to the present invention.

### DETAILED DESCRIPTION

### 1. DEFINITIONS

As used herein, the terms “sheet”, “ply” and “layer” refer to structures whose primary dimension is X-Y, i.e., along its length and width. As used herein, the term “sheet” refers to a sheet which can be a mono-ply structure, or a multi-ply structure. As used herein, the term “multi-ply sheet” refers to a sheet comprised of at least two plies. Each individual ply in turn can be a single-layer ply or a multi-layered ply. A multi-layered ply refers to a ply comprised of at least two layers.

As used herein, the term “sheets arranged in a stacked configuration” means that sheets, are stacked vertically on each other, i.e. orthogonal to the length and width of the disposable mat 10.

As used herein, the term “disposable” means that the disposable mat and all components thereof are designed for use for only a limited period of time (e.g. about 2-4 weeks), and are then preferably discarded, opposed to durable mats which are used for an extended period of time (several months).

### 2. DISPOSABLE MAT

The present invention relates to a disposable mat 10. Preferably, the disposable mat 10 is a domestic floor mat which can be used inside and outside a home. The disposable mat 10 of the present invention can also be used in cars, toilets, bathrooms, garages, or for absorbing spills. The disposable mat 10 is preferably at least partially, more preferably completely compostable or recyclable.

The disposable mat 10 can have any shape which is common for mats, such as a substantial rectangular, a substantial oval or a substantial rounded shape, but is preferably substantial rectangular in shape. Preferred dimensions for the disposable mat 10 are about 45 cm×about 65 cm. The disposable mat 10 preferably has a width from about 35 cm to about 55 cm, more preferably from about 40 cm to about 50 cm, and preferably a length from about 55 cm to about 80 cm, more preferably from about 60 cm to about 75 cm. The thickness of the disposable mat 10 is preferably less than 2 cm, more preferably less than 1 cm, and most preferably less than 0.75 cm, such that the disposable mat 10 will not interfere with opening and closing of doors.

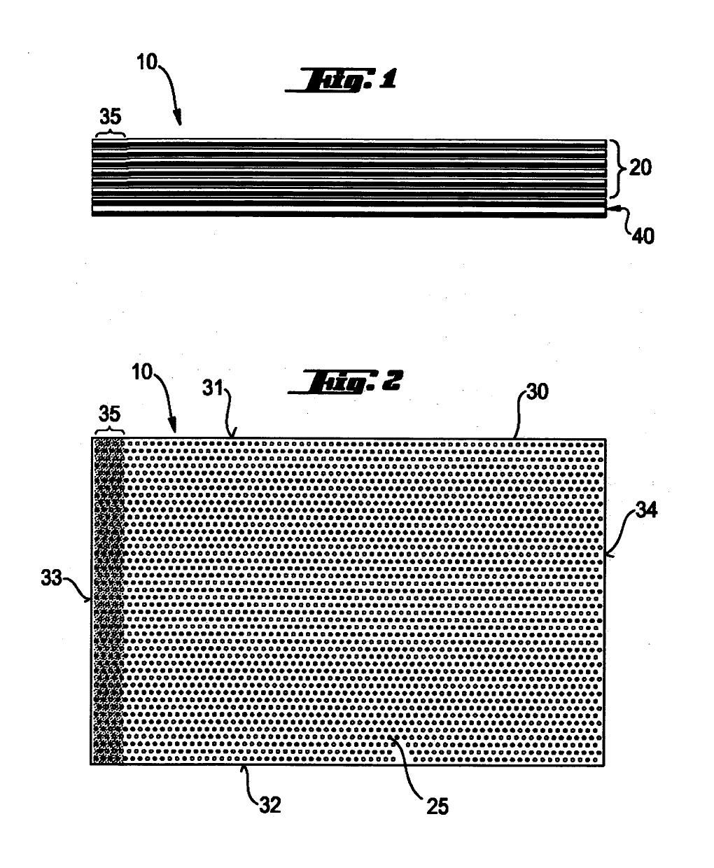

As shown in FIGS. 1 and 3, the disposable mat 10 according to the present invention comprises at least two removable sheets 20, arranged in a stacked configuration, each of the removable sheets 20 comprising an upper surface 21 and a lower surface 22. Each removable sheet 20 functions as a mat by itself, and can be easily removed once soiled. Preferably, the disposable mat 10 comprises at least 4 removable sheets 20, more preferably at least 6 removable sheets 20. In the embodiment where the disposable mat 10 is designed to be easily rolled-up, it is preferred that the disposable mat 10 comprises no more than 15 removable sheets 20, more preferably no more than 12 removable sheets 20, even more preferably no more than 10 removable sheets 20. Most preferred is that the disposable mat 10 comprises from 6 to 8 removable sheets 20.

In a preferred embodiment, the kinetic coefficient of friction between the lower surface 22 of a first removable sheet 20, and the upper surface 21 of a second removable sheet 20 positioned directly underneath said first sheet, is from about 0.4 to about 4. Preferably, the kinetic coefficient of friction is from about 0.5 to about 3, more preferably from about 0.6 to about 2, even more preferably from about 0.8 to about 1.5. This ensures that the sheets do not slip or slide with respect to one another when a person steps on the mat, or cleans the soles of his shoes. Surprisingly the sheets having a kinetic coefficient of friction within these ranges, are able to slip over one another when no pressure is applied to the mat, without buckling.

When more than 2 removable sheets 20 are present, the kinetic coefficient of friction between the lower surface 22 of each removable sheet 20 and the upper surface 21 of another removable sheet 20 positioned directly underneath that sheet has a value as defined hereinabove. The kinetic coefficient of friction between sheets across the stack, may be the same, or it may be different. For example, the kinetic coefficient of friction between two sheets which are positioned more to the top of the disposable mat 10, may be lower or higher than the kinetic coefficient of friction between two sheets which are positioned more to the bottom of the disposable mat 10. As such, a kinetic coefficient of friction gradient can be created across the stack of removable sheets 20, in a vertical direction. In another embodiment, the kinetic coefficient of friction may vary across the lower surface 22 in a horizontal plane, to create a horizontal gradient. For example, when the removable sheets 20 are attached to each other at or adjacent to one side of the disposable mat 10, the kinetic coefficient of friction may be higher at the opposite side.

The kinetic coefficient of friction is measured according to ASTM method D-1 894, under a weight of 200 grams. The method is explained in the Test Methods section.

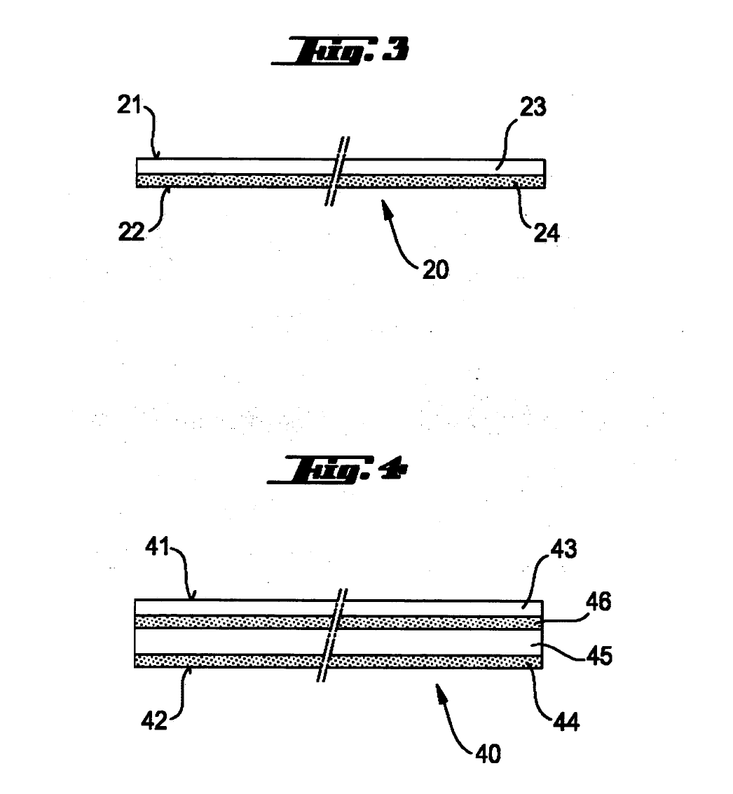

The at least two removable sheets 20 are attached to a support sheet 40 at or adjacent to at least a portion 35 of the perimeter edge 30 of the support sheet 20, as shown in FIG. 2. Preferably, the at least two removable sheets 20 are attached to the support sheet 40 at or adjacent to at least one side of the support sheet 40, as shown in FIG. 1. Even more preferably, as shown in FIG. 2, the disposable mat 10 has two long sides 31, 32 and two short sides 33,34, and the removable sheets 20 are attached to the support sheet 40 at or adjacent to at least a portion of one short side 33. More preferably, the sheets are attached to the support sheet 40 adjacent substantially the entire length of one short side 33. In a highly preferred embodiment, the removable sheets 20 are attached to the support sheet 40 only at or adjacent to one short side 33. This latter embodiment allows the disposable mat 10 to be easily rolled up, starting from the short side where the removable sheets 20 are attached to the support sheet 40 such that this side is inside the rolled-up mat. As the removable sheets 20 are being rolled up, it is important that the removable sheets 20 are allowed to slide over each other which prevents wrinkling of the removable sheets 20.

If the removable sheets 20 of the disposable mat 10 are bonded or attached at many locations (for example, across the surface of the mat, or across many points along the entire the perimeter) or if the kinetic coefficient of friction is too high, the removable sheets 20 cannot slide and the removable sheets 20 will become wrinkled as the disposable mat 10 is being rolled up. This problem exists for example with disposable mats of the prior art where an adhesive is used to attach the removable sheets together. Wrinkling is not desired as it would negatively impact the aesthetics and the use of the disposable mat 10. This becomes more of a problem when the number of removable sheets 20 in the disposable mat 10 is increased, since the inner diameter is shorter than the outer diameter of the rolled-up mat. The higher the length of the disposable mat 10 is, will also increase the number of wrinkles if the removable sheets 20 are not allowed to slip over one another.

Preferably, the removable sheets 20 are bonded to the support sheet 40. Any bonding method know in the art can be used, however, bonding methods that create heat, and thus melt the sheets together, are preferred. Bonding the sheets together provides benefits over other attaching techniques, such as adhesives or mechanical means (e.g. clips, rings, grippers), because the removable sheets 20 are more strongly attached, yet are still easy to remove from the disposable mat 10. Preferred bonding methods include thermal bonding, ultrasonic bonding, and pressure bonding. The advantage of ultrasonic bonding is that several relatively thick sheets can be bonded throughout the stack without driving a lot of heat through one or both sides. Another preferred bonding method is high pressure bonding, as described in U.S. patent application Ser. No. 10/456,288, filed on Jun. 6, 2003 (McFall et al.). This method is now described in the context of a disposable mat 10 comprising a stack of disposable sheets. The bonding process comprises feeding a stack of sheets through at least a pair of cylindrical rolls, with at least one of the rolls having a relief pattern on its surface formed by a plurality of protruberances or pattern elements extending outwardly from the surface of the roll. The other cylindrical roll serves as an anvil member, and together the patterned roll and the anvil roll define a pressure biased nip therebetween. Preferably, the anvil is smooth-surfaced, however both rolls may have a relief pattern thereon. The patterned roll and anvil roll are preferably biased towards each other with a loading of from about about 140 MPa to about 1400 MPa. The patterned roll and the anvil roll are preferably driven in the same direction at different speeds, so that there is a surface velocity differential therebetween. The surface velocity differential preferably has a magnitude of from about 2 to about 40% of the roll having the lower surface velocity, more preferably between about 2 to about 20%. The anvil roll is preferably operated at a surface velocity that is greater than that of the patterned roll. It is also possible, however, that high line velocities for bonding to occur at zero velocity differential. Another highly preferred bonding method for bonding the removable sheets 20 together, is embossing. In one preferred embodiment, the bonded area is a continuously bonded area. In an alternative, but also preferred, embodiment, the bonded area is a discontinuously bonded area.

Preferably the 180-degree peel force of the bond between sheets to keep the sheets from coming apart during use is, on average, preferably from 0.3 N/cm to 4 N/cm, more preferably from 0.5 N/cm to 3 N/cm, and most preferably from 0.8 N/cm to 2 N/cm. The seal strength of the bond between two sheets is measured with an Instron Tensile Tester from Instron Corporation of Norwood, Mass. with a 2.54 cm gauge length and a crosshead speed of 30.5 cm/min. This method is performed by cutting a sample of the disposable mat 10, of 2.54 cm wide by 15 cm long, using a specimen cutter such that the bond to be tested is perpendicular to the length of the sample and the bond being measured should be on one end of the sample. The sample should also be taken such that it captures a full 2.54 cm of bond width such that the entire width of the sample is bonded at one end. The loose ends of the sample are clamped into the jaws of the Instron Tensile Tester by squarely putting one sheet in the top jaw and squarely putting another sheet end in the bottom jaw. The Instron Tensile Tester then pulls the sheet sample at a 180 degree angle and the force is measured to pull the sheets apart. This average force is recorded in Newtons/cm of seal width.

Alternatively, the lower surface 22 of each removable sheet 20, may comprise a region, preferably a strip at or adjacent to, and having a length substantially the length of a short side, which has a kinetic coefficient of friction of at least 5 against the upper surface 21 of a removable sheet 20 just beneath it (the lowest removable sheet 20 of the stack having a strip with a kinetic coefficient of friction of at least 5 against the upper surface 41 of the support sheet 40). Materials providing such a high kinetic coefficient of friction are more sticky, and when pressed, the removable sheets 20 can be attached to each other at this region or strip.

As shown in FIG. 3, the removable sheets 20 are preferably multi-ply sheets, comprising an upper ply 23 and a lower ply 24, preferably laminated together. The upper ply 23 is absorbent, and preferably comprises a nonwoven layer. Materials particularly suitable for forming the preferred nonwoven layer are, for example, natural materials, as well as synthetic materials. Also useful are natural fibers, such as cotton or blends thereof and those derived from various cellulosic sources. Nonlimiting examples of natural materials useful in the present invention include, but are not limited to, silk fibers, keratin fibers and cellulosic fibers. Nonlimiting examples of cellulosic fibers include those selected from the group consisting of wood pulp fibers, cotton fibers, hemp fibers, jute fibers, flax fibers, and combinations thereof. Nonlimiting examples of synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers, formed films, films, and combinations thereof. These and other suitable fibers and the nonwovens prepared therefrom are generally described in Riedel, “Nonwoven Bonding Methods and Materials,” Nonwoven World (1987); The Encyclopedia Americana, vol. 11, pp. 147-153, and vol. 26, pp. 566-581 (1984); U.S. Pat. No. 4,891,227, to Thaman et al., issued Jan. 2, 1990; and U.S. Pat. No. 4,891,228. As used herein, “nonwoven” means that the layer comprises fibers which are not woven into a fabric but rather are formed into a sheet, mat, or pad layer. The fibers can either be random (i.e., randomly aligned) or they can be carded (i.e., combed to be oriented in primarily one direction). More preferred synthetic fibers for the nonwoven layer are solid staple polyester fibers, which comprise polyethylene terephthalate homopolymers. Suitable synthetic materials may include solid single component and multicomponent synthetic fibers, i.e., more than one type of material making up the fibers. The synthetic fibers may comprise bicomponent or dual component fibers. Such bicomponent fibers may have a core and a sheath configuration or a side-by-side configuration. In either instance, the substrate layer may comprise either a combination of fibers comprising the above-listed materials or fibers which themselves comprise a combination of the above-listed materials. For the core-sheath fibers, preferably, the cores comprise materials selected from the group consisting of polyesters, polyolefins having a T_{g} or melting point of at least about 10° C. higher than the sheath material, and combinations thereof. Conversely, the sheaths of the bicomponent fibers preferably comprise materials selected from the group consisting of polyolefins having a T_{g} or melting point of at least about 10° C. lower than the core material, polyesters polyolefins having a T_{g} or melting point of at least about 10° C. lower than the core material, and combinations thereof. In any instance, side-by side configuration or core-sheath configuration, the fibers of the substrate layer may exhibit a helical or spiral configuration, particularly the bicomponent type fibers.

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed. The resulting layer, regardless of its method of production or composition, is then subjected to at least one of several types of bonding operations to anchor the individual fibers together to form a self-sustaining web. In the present invention the nonwoven layer can be prepared by a variety of processes including, but not limited to, meltblowing, spunbonding, air-entanglement, hydroentanglement, thermal bonding, needle-punching, and combinations of these processes. Nonwoven structures formed by hydroentanglement and/or heat-bonding are particularly preferred since they provide highly desirable open structures. As used herein, the term “hydroentanglement” means generally a process for making a material wherein a layer of loose fibrous material (e.g., polyester) is supported on an apertured patterning member and is subjected to water pressure differentials sufficiently great to cause the individual fibers to entangle mechanically to provide a fabric. The apertured patterning member can be formed, e.g., from a woven screen, a perforated metal plate, etc.

Nonwoven structures comprising synthetic materials or fibers, preferably polyesters, especially carded polyester fibers, typically have desirable electrostatic properties, which is preferred. The degree of hydrophobicity or hydrophilicity of the fibers is optimized depending upon the desired goal of the layer, either in terms of type of soil to be removed, biodegradability, availability, and combinations of such considerations. In general, the more biodegradable materials are hydrophilic, but the more effective materials tend to be hydrophobic. The nonwoven structure typically has a total aggregate basis weight of at least about 20 g/m², preferably at least about 40 g/m², and is typically no greater than about 150 g/m², preferably no greater than about 100 g/m², and more preferably no greater than about 70 g/m².

As shown in FIG. 2, in one preferred embodiment, the upper ply 23 is apertured. The apertures 25 preferably have an opening, on average, of from about 1 mm² to about 2 mm², and provide an open area of from about 20% to about 60%, more preferably from about 30% to about 50% of the upper ply's 23 upper surface. The upper ply 23 preferably has a thickness of at least about 0.1 mm, more preferably from about 0.1 mm to about 2 mm, even more preferably from about 0.1 mm to about 1 mm, and most preferably from about 0.1 mm to about 0.5 mm. The combination of apertures 25 in the upper ply 23, and the thickness thereof, create a three dimensional surface, thereby enhancing the removal of soil from the soles of shoes. The apertures 25 create areas where soil can be deposited and the non-apertured areas become the surface which scrape the bottom of shoes. The thickness of the upper ply 23 is also very beneficial to the removal of soil from shoes. In general, a thicker upper ply 23 will allow more material to conform to the shape and ridges of a shoe and will thus do a more effective job of removing soils.

A relatively thick, three-dimensional absorbent material is preferred for trapping and locking both dry and wet soils. One way to achieve this thicker structure without using a lot of material is to use a nonwoven layer that has been formed on a three-dimensional screen. The nonwoven in a wet- or dry-laid process will take on the shape of the screen and results in a thicker structure for the same basis weight since there is no material in apertured region. This becomes an effective way of increasing thickness and scrubbing capability of a material while minimizing the cost of increasing the basis weight.

One example of a preferred nonwoven layer is a 50-60 gsm hydroentangled non-woven comprised primarily of cellulose fiber and formed on a screen with openings of approximately 1 mm×2mm, having a thickness of about 0.3 mm. Other preferred methods for creating increased three-dimensionality, are described in WO application number 2004/020725, and U.S. Pat. No. 5,968,029, both assigned to The Procter & Gamble Company.

Optionally, adding from about 1 g/m² to about 5 g/m² of a latex binder to the nonwoven layer, may further increase the wet strength of the nonwoven structure. This is important when someone with wet shoes is using the disposable mat 10.

The lower ply 24 is water-impermeable to ensure that water and wet dirt is not transferred to a fresh sheet, or sheets, underneath the sheet which is in use. The lower ply 24 preferably comprises a polyolefin material, such as polyethylene, polypropylene, ethylene vinyl acetate, ethylene-ethyl acrylate, or ethylene-methyl acrylate. Other suitable materials may be polyesters, vinyls, or other thermoplastic polymers. In a preferred embodiment, the lower ply 24 comprises a co-extruded film comprising at least one layer comprising about 10% of a polyolefin material. With co-extruded film, it is meant a film comprising two or more layers created from a single extrusion process. The advantage of a co-extruded film is that a multi-layer can be created having opposing surfaces with different properties, for example the upper surface may have good tensile properties for manufacturing and be water-impermeable, while the lower surface may have a high kinetic coefficient of friction to keep the removable sheets 20 from slipping when a person is removing dirt from their shoes. Another advantage of a co-extruded film is that the film can be made to have a lower melting temperature on one side versus the other side. This allows the film to be selectively removable from one side when heat sealed. For example, as shown in FIG. 8, the co-extruded film 60 can be a co-extruded film having 3 layers 61,62,63. The upper layer 61 can be a polyethylene with 10-30% ethylene vinyl acetate to lower it's melting temperature and to increase it's adhesion to the upper ply 23. The middle layer 62 can be polypropylene which has a higher melting temperature and has good tensile properties for manufacturing the film. The lower layer 63 has a high kinetic coefficient of friction to other materials such as e.g. the nonwoven structure and is used to keep the removable sheets 20 from slipping. Suitable materials for the lower layer 63 are thermoplastic elastomers (TPE) or blends of a thermoplastic elastomer and other polymers, and can be obtained from GLS Corporation of McHenry, Ill. Other suitable materials for the lower layer 63 are blends comprising ethylene vinyl acetate, vinyl-based coatings, or rubber-based materials. Other possibilities for creating a lower layer 63 having a high kinetic coefficient of friction, is to create a three-dimensional surface (i.e. the surface which contacts the upper layer of a removable sheet underneath), with peaks and valleys. Examples of films having such a three-dimensional surface are vacuum or embossed formed films. An adhesive, preferably a pressure sensitive adhesive, may be applied in the valleys. As such, in use, the adhesive in a removable sheet 20 is contacting the upper surface of a removable sheet underneath it, as the three-dimensional surface would flatten under pressure, thereby preventing the sheets to slip. When no pressure is applied to the disposable mat (i.e. when not in use), the adhesive does not contact the surface of the removable sheet 20 underneath, hence, allows the removable sheets 20 to slide and thus rolling-up of the disposable mat 10.

The lower layer 63 also preferably has a melting temperature higher than upper layer 61 such that when the removable sheets 20 are bonded, the lower layer 63 tends to stay connected to the upper layer 61 when peeling off a dirty sheet from the stack of removable sheets 20. This allows the removable sheets 20 to be peeled off, without ripping the removable sheet 20 below.

The thickness of the lower ply 24 will also affect its ability to be peeled off without tearing. Preferably, the lower ply 24 has a thickness of at least 12 micrometers, more preferably at least 18 micrometers. The lower ply 24 can generally be as thick as 50-75 micrometers but this thickness is less preferred since it results in more solid waste and is not necessary for keeping the next sheet dry. Alternatively, the lower ply 24 can also be a laminate of 2 or more layers or can be made with blown or cast extrusion processes.

The lower ply 24 can be attached to the upper ply 23 by a variety of means including adhesive lamination with a hot melt adhesive, an aqueous adhesive or a solvent adhesive. The lower ply 24 can also be attached to the upper ply 24 by extrusion coating the lower ply 24 directly onto the upper ply 23. This extrusion coating step eliminates the need for a separate adhesive laminating step and avoids the cost of adhesive.

Optionally, an adhesive or tacky additive that improves the pick-up and retention of soil and dirt, may be present between the upper and lower ply 24, when an apertured ply is used. Preferred adhesives are pressure-sensitive adhesives. This particular embodiment also aids in temporarily increasing the kinetic coefficient of friction between removable sheets 20, as the adhesive would only be exposed through the apertures, in use, and thus contacting the sheet above when pressure is applied to the disposable mat 10.

In order to enhance the perception of the three-dimensionality, it is preferred that the upper ply 23 and the lower ply 24 have a contrasting color, as shown in FIG. 3. Although it is preferred that the upper ply 23 has a lighter color than the lower ply 24, the opposite may provide the same effect. Preferred colors of the upper layer are shades of brown, red, or blue such that the mat doesn't look too dirty immediately but also will eventually show dirt when it has been used multiple times and needs to be changed.

It is also preferred to print the upper surface 21 of each removable sheet 20 with aesthetically pleasing graphics, patterns, pictures, cartoons, logo's, branding information, or any combination thereof. These aid in camouflaging dirt retained by the removable sheets 20, or dirty foot prints on the upper surface 21 of a removable sheet 20, thereby increasing the use-life of each of the removable sheets 20. The optional latex binder, as previously described, can also have pigments or ink added so as to add color to the nonwoven structure and thus improve the appearance and ability camouflage dirt. Also useful are printable dyes that fade through use, such that it is indicated when a removable sheets 20 needs to be replaced.

The disposable mat 10 according to the present invention comprises a support sheet 40, as shown in FIG. 1, attached to the at least two removable sheets 20. The support sheet 40 provides stiffness, non-slip and cushioning to the stack of removable sheets 20 of the disposable mat 10.

The support sheet 40 comprises a foam, preferably a polyolefin based foam. The foam provides stiffness to the stack of removable sheets 20. Furthermore, in use, the foam would further increase the kinetic coefficient of friction between the support sheet 40, and the surface on which the disposable mat 10 is placed, as the foam would conform to surface irregularities of e.g. a floor, thereby increasing the total surface area of the lower surface 42 of the support sheet 40 that is in contact with the surface on which the disposable 10 mat is placed. Similarly, in use, the foam would also aid in keeping the removable sheets 20 together, as the foam would conform to the sole of the shoe.

The foam has a density of from about 0.005 to about 0.5 g/cm³, preferably from about 0.008 to about 0.15 g/cm³ as defined by the Immersion Density Method described below. Preferred foam materials are those that are sufficiently rigid. It is desirable for the support layer comprising a foam to not buckle or roll-up during use, i.e., be resistant to bending. The ability of an article to remain flat and resist bending can be measured by an engineering test known as Three Point Bending (e.g., as described in ASTM Standard D 790-99, “Flexural Properties of Unreinforced and Reinforced Plastics and Electrical Insulating Materials”). The foam preferably has a rigidity in the Machine Direction from about 0.20 g/cm/cm to about 35.0 gm/cm/cm as defined by the Three Point Bending Rigidity Method described below. The basis weight of the foam is preferably from about 1 gsm to about 250 gsm, preferably from about 3 gsm to about 200 gsm, more preferably from about 5 gsm to about 150 gsm, even more preferably from about 7.5 gsm to about 100 gsm, still even more preferably from about 10 gsm to about 80 gsm. The foam can be in the form of open cell, closed cell, double cell, reticulated foams, loaded foams, multiple layer foams and combinations thereof. Preferably, the foam layer is a closed-cell foam. Additionally, the foam can be extruded as a rope lattice, sheets or in strands. Nonlimiting examples of foam materials useful in the present invention include, but are not limited to polyethylene foams, polypropylene foams, vinyl foams, acrylic foams, polyether foams, polyester foams, polyurethane foams, foam comprising blends of miscible and immiscible polymers and copolymers, silicone sponge foam, neoprene foams, rubber foams, polyolefin foams and mixtures thereof. Preferably, the foam material is polyethylene (PE) or polypropylene (PP). An example of a preferred foam is MicroFoam MF090 PP from Pavek of Chicago, Ill. The foam preferably comprises slits, corrugations or creases, preferably parallel to a short side of the disposable mat 10. This ensures that the foam can be easily rolled-up, yet returns to a flat configuration when the disposable mat 10 is unrolled and placed on a surface. These slits, corrugations or creases can be made during foam manufacturing, or by post processing.

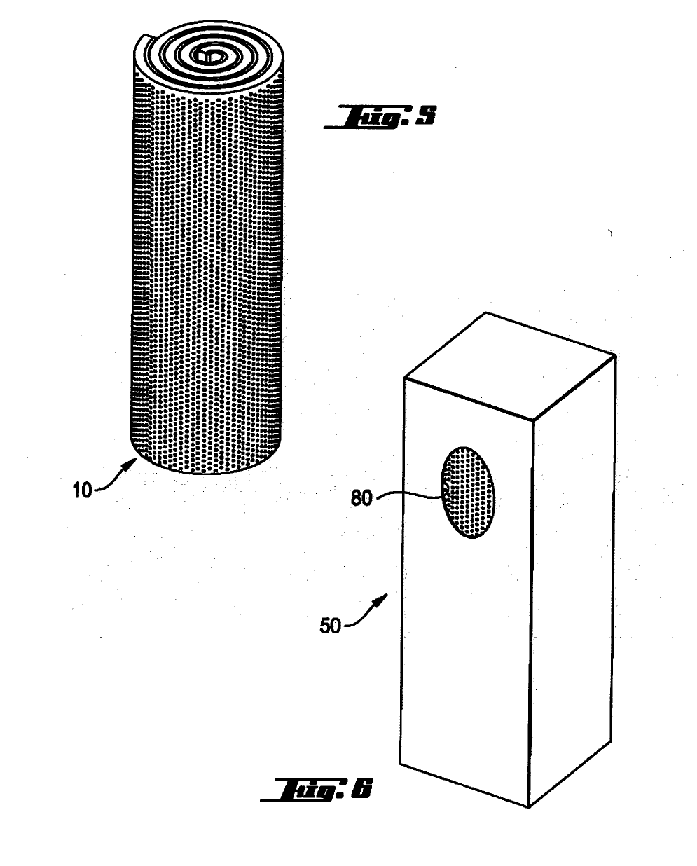

As shown in FIG. 4, the support sheet 40 is preferably a multi-ply sheet, comprising an upper ply 43 and a lower ply 44, both of which preferably have the same properties as the upper and lower ply 23, 24 respectively of each of the removable sheets 20. As such, in addition to the other benefits provided, the support sheet 40 itself functions as a mat when the last removable sheet 20 of the stack is removed from the disposable mat 10. The support sheet 40 preferably further comprises an intermediate ply 45, positioned between the upper ply 43 and the lower ply 44, the intermediate ply 45 preferably comprising the foam.

As shown in FIG. 4, the support sheet 40 comprises an upper surface 41 and a lower surface 42. The kinetic coefficient of friction between the lower surface 22 of the sheet of the stack of removable sheets 20, which is positioned directly above the support sheet 40, and the upper surface 41 of the support sheet 40 is preferably at least about 0.4, more preferably from about 0.4 to about 4, even more preferably from about 0.5 to about 3, even more preferably from about 0.6 to about 2, and most preferably from about 0.8 to about 1.5. In order for the support sheet 40 to stay in position, the kinetic coefficient of friction between the lower surface 42 of the support sheet 40, and a surface on which the disposable mat 10 is placed, is preferably at least about 0.4, more preferably from about 0.4 to about 4, even more preferably from about 0.5 to about 3, and most preferably from about 0.6 to about 2. Alternatively, the lower surface 42 of the support sheet 40 may be treated with an adhesive, however, this is less preferred.

The support sheet 40 is attached to the stack of removable layers 20, preferably bonded with any of the bonding methods described hereinabove. Even more preferably, the removable sheets 20 and the support sheet 40 are bonded simultaneously.

In a highly preferred embodiment, as shown in FIG. 4, the support sheet 40 comprises an upper ply 43, a lower ply 44 and an intermediate ply 45, according to the above description, and an additional ply 46 positioned between the upper ply 43 and the intermediate ply 45. The additional ply 46 is preferably water-impermeable and comprises a polyolefin, or a co-extruded film comprising at least 10% of a polyolefin material, and has a darker color than the upper ply.

In one embodiment, the disposable mat 10 comprises at least one environmentally degradable material. Preferably, the disposable mat, and all components thereof, are made of environmentally degradable materials. Examples of suitable environmentally degradable thermoplastic polymers for use in the present invention include aliphatic polyesteramides; diacids/diols aliphatic polyesters; modified aromatic polyesters including modified polyethylene terephthalates, modified polybutylene terephthalates; aliphatic/aromatic copolyesters; polycaprolactones; polyesters and polyurethanes derived from aliphatic polyols (i.e., dialkanoyl polymers); polyamides including polyethylene/vinyl alcohol copolymers; polyhydroxycarboxylic acids; lactic acid polymers including lactic acid homopolymers and lactic acid copolymers; lactide polymers including lactide homopolymers and lactide copolymers; glycolide polymers including glycolide homopolymers and glycolide copolymers; and mixtures thereof. The environmentally degradable thermoplastic polymer or copolymer may also be destructured starch or thermoplastic starch. Since natural starch generally has a granular structure, it needs to be destructured before it can be melt processed. Commonly, starch is destructured by dissolving the starch in water. The term “thermoplastic starch” means starch destructured with a plasticizer. Suitable naturally occurring starches can include, but are not limited to, corn starch, potato starch, sweet potato starch, wheat starch, sago palm starch, tapioca starch, rice starch, soybean starch, arrow root starch, bracken starch, lotus starch, cassava starch, waxy maize starch, high amylose corn starch, and commercial amylose powder. Blends of starch may also be used. Though all starches are useful herein, preferred are natural starches derived from agricultural sources, which offer the advantages of being abundant in supply, easily replenishable and inexpensive in price such as corn starch, wheat starch, and waxy maize starch. Exemplary starches that may be used in the present invention are StarDri 100, STADEX® 10, STADEX® 15, or STADEX® 65, all from Staley. STADEX® 10 and STADEX® 15 are white dextrin from dent corn starch. These dextrins have low solubility in cold water and are used as binders in adhesive applications where high viscosity is required. STADEX® 65 is also a white dextrin from dent corn starch, has medium solubility in cold water and is used as a binder in adhesive applications where high viscosity at medium solids level is required. The StarDri materials are pre-destructured multidextrin starches typically used in food applications. Preferred environmentally degradable materials are described in WO application number 2004/101683, Zhao et al, and U.S. Pat. No. 5,292,860, Shiotani et el.

### 3. PACKAGING OF THE DISPOSABLE MATS

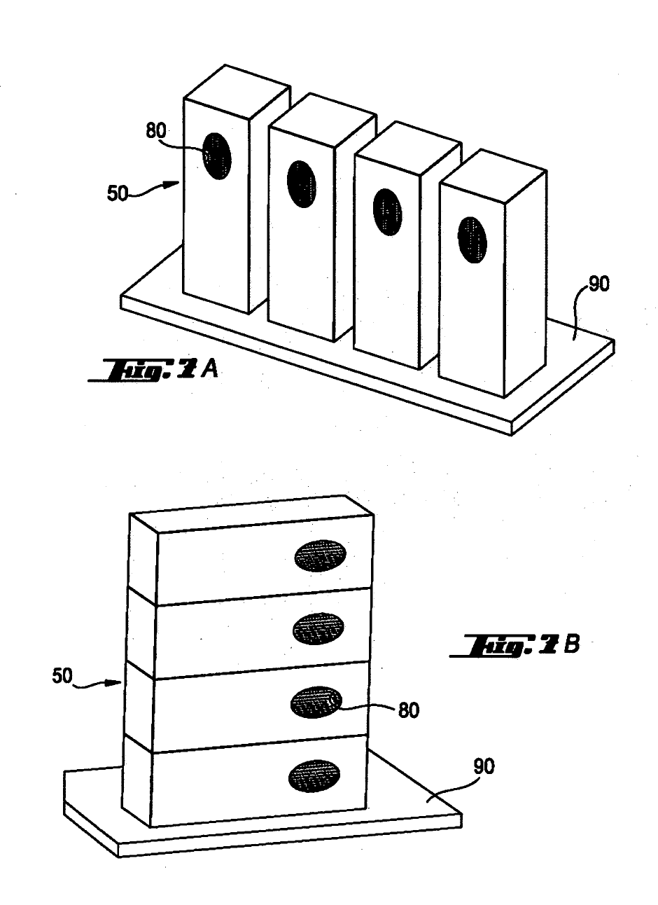

As shown in FIGS. 5, 6, the disposable mat 10 according to the present invention is preferably packaged, rolled-up in a cylindrical configuration. This allows the disposable mat 10, which has rather large dimensions, to be displayed for sale in a container 50 which has smaller dimensions than the mat. When rolled up, the disposable mat 10 can fit in a container 50 having dimensions of about 7.5 cm×about 7.5 cm×about 45 cm. Alternatively, two or more disposable mats may be packed in one container 50.

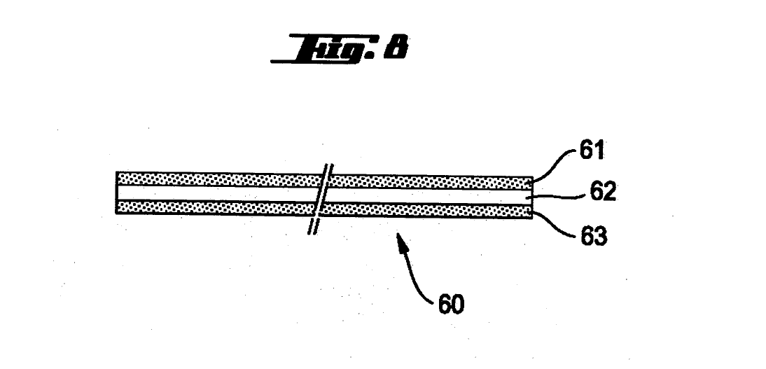

In one preferred embodiment, the container 50 is a plastic or cardboard box. As such, several containers 50 can be stacked on top of each other, or they can be placed next to each other, as shown in FIGS. 7a, 7b. In another preferred embodiment, the container 50 is a flexible container 50, such as e.g. a flow wrap. This allows the disposable mats to be easily displayed on shelves 90 (as they would occupy less space), rather than being placed in unrolled configuration on the floor. This further provides the benefit that the disposable mat 10 can be easily transported. The container 50 is preferably at least partially transparent. Even more preferably, the container 50 comprises an opening 80, or a combination of a transparent portion and an opening. This allows a consumer to inspect and/or feel the disposable mat 10. The container 50 preferably comprises usage instructions, the usage instructions comprising the steps of:
i) unrolling the disposable mat and placing the mat on a surface, and
ii) removing and discarding the upper sheet when said upper sheet is soiled

### 4. PROCESS OF MANUFACTURING A DISPOSABLE MAT

A preferred process for manufacturing a disposable mat 10 with a stack of removable sheets 20 involves laminating or coating a water-impermeable film to a nonwoven layer and creating rolls of this structure. A number of rolls corresponding to the number of removable sheets 20 in a mat are being produced (including a roll for the optional unique support layer 40) are then unwound and layed on top of each other. The sheets are then bonded in the machine direction along one edge using a bonding method such as thermal bonding, ultrasonic bonding, pressure bonding or embossing, and the sheets are then die-cut to the correct size by cutting through all the sheets in one step. The disposable mat 10, cut at the preferred dimensions, is then rolled-up with the film facing inward and the nonwoven facing outward. The rolled-up disposable mat 10 is then inserted in a container.

### 5. TEST METHODS

Coefficient of Friction

The coefficient of friction is the ratio of the force required to move one surface over another to the total force applied normal to those surfaces. The kinetic coefficient of friction is the ratio of the force required to move one surface over another to the total force applied normal to those surfaces, once that motion is in progress. The static coefficient of friction is the ratio of the force required to move one surface over another to the total force applied normal to those surfaces, at the instant motion starts. The kinetic coefficient of friction (CoF) described in this application is measured according to ASTM method D1894. These coefficient of friction values are determined using a weighted sled with a test material attached to the bottom and then measuring the force to pull this sled across a test surface. The sled is a 2.5″ square (6.35 cm²) sled with a foam bottom per ASTM method D1894 and has a total weight of 200 grams. A sample material is attached to the bottom of the sled and the same material or another material is fastened to a smooth plane. The sled is pulled at 6 inches/minute (15.24 cm/minute) and the average force to pull the sled on the test surface is measured. The coefficient of friction is the force to pull the sled divided by the 200 gram normal force from the weight of the sled. For example, to test the CoF of a typical low density polyethylene film on a ceramic tile, a 25 micron thick polyethylene film is mounted to the bottom of the sled. A ceramic tile is mounted on the plane of the testing device. The 200 g sled is then placed on the ceramic tile and the force to initiate movement of the sled is measured as well as the average force to pull the sled at 6 inches/minute (15.24 cm/minute). The initial force is measured to be 0.05 kg and the average force to pull the sled is 0.06 kg. The static coefficient of friction is thus 0.25 ( 0.05 kg/0.2 kg) and the kinetic coefficient of friction is 0.30 (0.06/0.2 kg).

Three Point Bending Rigidity Method

Three Point Bending of materials produces data relating the stress-strain properties of the materials. Because it is common to test materials of differing length, thickness and width, equations are used to reduce data to common units for comparison. For Three Point Bending, Equation 1 can be used, and can be combined with Equation 2 for a rectangular strip of material, which can be a foam, a foam composite, layers comprising foam, or an article.

$$\begin{matrix}E = \frac{( F ) {( L )}^{3}}{( v ) ( 6 ) ( I )} \\ F = force \\ L = length of sample \\ I = moment of inertia of sample \\ v = displacement \\ E = elastic modulus of material & Equation 1 \\ I = \frac{( b ) {( h )}^{3}}{12} \\ b = width of sample \\ h = thickness of sample & Equation 2 \\ \frac{F}{( ( b ) ( v ) )} = \frac{( E ) {( h )}^{3}}{( 2 ) {( L )}^{3}} & Equation 3\end{matrix}$$

Three Point Bending Rigidity Method is tested on a Texture Analyzer model TA-xt2i (Texture Technologies, Scarsdale, N.Y., USA) using a 5 kg load cell, a three point bending geometry, and samples (web materials or articles) having widths and lengths of about 3.0 inches (7.62 cm) and 5.5 inches (13.97 cm). First, a lower stage is established for the test, consisting of two parallel beams each having an outer diameter of 1.05 inches (2.67 cm). Schedule 40 pipe having a ¾ in. inner diameter is widely available, easy to use, and may be suitable for fabricating the lower stage. The lower stage is prepared so that the beams are fixed in a parallel position having a gap between them measuring 1.85 inches (4.7 cm) at the narrowest point (i.e., a center-to-center distance of 2.90 inches (7.37 cm)). The length of the beams is sufficiently long that a sample (a web or an article) may be balanced on the beams and be fully supported by the beams with the substrate clear of any support structures used to fix the beams in position. A length of 10 inches (25.4 cm) is effective for the beams. The lower stage is set in place at the base of the Texture Analyzer in a position high enough that an upper beam can penetrate through the space between the parallel beams of the lower stage during a measurement.

An upper stage is prepared, which comprises a T-shaped upper beam, having a measurement section and a bisecting section. The measurement section of the T-shaped upper beam is the middle beam as conventionally described in Three Point Bending literature, and the bisecting section is used to affix the T-shaped upper beam to the Texture Analyzer TA-xt2i. The upper beam has an outer diameter measuring 1.305 inches (3.315 cm) and a length measuring 3.10 inches (7.87 cm), measuring the central measurement section of the beam. The upper stage is affixed to the upper movable arm of the Texture Analyzer TA-xt2i in a position so that the measurement section (i.e., the middle beam of the Three Point Bending geometry) of the upper beam is parallel to the two parallel beams of the lower stage, all of which are positioned horizontally. The stages are fixed in position so that as the upper beam is lowered by the Texture Analyzer TA-xt2i, the upper beam advances vertically (downward) so that the measurement section intersects the plane of the lower stage midway between the parallel beams of the lower stage; and the advancement of the upper beam movement is in a direction perpendicular to the plane formed by the parallel beams of the lower stage. The upper beam is set at a starting position, which is a height where the lowest portion of the upper beam is 1.25 inches above the highest portion of the parallel beams on the lower stage. The instrument is calibrated properly and set to measure at an upper beam (i.e., Texture Analyzer TA-xt2i upper arm speed) velocity of 10 mm per second in a downward direction, measuring the force in compression. The instrument is programmed to travel a distance of 60 mm, collect force and displacement data (100 points per second minimum) and return to the starting position.

Web and article are used interchangeably to mean both in the following, and a strip can be of either. A first sample is prepared by cutting a web or article into a strip measuring 3 inches (7.62 cm) wide and 5.5 inches (13.97 cm) long with the long dimension in the MD; a second sample is prepared by cutting a web or article into a strip with the long dimension in the CD. If preparing an article delaminates it, the ends of the article or strips are taped to maintain integrity. If articles are sealed near an edge (within 5 mm), then at least some strips cut should include the sealed edge portion of the article. Rigidity in the Machine Direction (MD) is measured. A first strip is placed flat across the lower stage beams with the long dimension traversing the gap between the lower beams, being careful not to bend the strip during preparation, the major axis of the strip orthogonal to the axis of the lower beams, and is centered on the beams in a position immediately below the upper beam. The upper beam advances at a rate of 10 mm/sec downward, at first contacting and then bending the strip, collecting force-displacement information. The results are plotted as force (F, y-axis in grams) and displacement (v, X-axis in centimeters). Displacement is plotted as its absolute value so that it is increasing and positive with downward movement with the upper beam. The rigidity is determined from a graph of the results. The results have a first portion where F is equal to zero (prior to contact); a second portion where F is greater than zero and increasing non-linearly (i.e., curving upwards on the graph) due to a sum of preliminary forces on the article (compression and bending, e.g.); and a third portion where a primary force component is the force necessary to bend the article. Results in the third portion are used to evaluate the rigidity. At least a fourth portion of the results is often visible, where the force begins to plateau, and may level out and remain flat or level out and increase due to compression of thick samples between the side beams and center beam, which results are not used. A linear portion of the results is selected within the third portion of the results, after the end of the curved second portion and prior to the onset of the fourth portion of the results, and the slope of the graph is determined by regression, which is F/v and is expressed in grains/cm. The linear portion of the results selected is broad enough that the results are not overly influenced by noise or jaggedness of the results, so that the results are representative of the trend, usually about 0.2 to 0.6 cm in width. If a linear portion is not apparent, a region is selected by choosing the data range between one sixth and one half the highest force obtained for the measurement as the range for regression of the slope. The resulting slope is divided by the width of the sample in cm (usually 7.62 cm) to obtain the MD Rigidity, in grams/cm/cm, which normalizes the rigidity by width. A sufficient number of samples are measured to obtain a representative average, alternating the side of the sample facing upwards for each subsequent measurement. Second strips, having long dimensions in the CD, are measured and results evaluated in the same manner to obtain the Rigidity in the Cross Machine Direction (CD).

Immersion Density Method

The densities of the articles of the present invention can be determined using the immersion Density Method. Density of foam webs with a substantially closed structure, e.g. many foams, is measured by buoyancy in a fluid of known density, which is excluded from the interior structure of the web foam during the measurement. Water is used as the immersion fluid, having a density of 1.00 g/cm³.

About 500 ml of water is placed in a clear-walled beaker, for example a glass, 800 ml beaker, and allowed to stand (covered) to de-aerate for 1 day. The beaker containing water is placed on an analytical balance, and the balance is zeroed. A stand with a height adjustable arm is placed near the balance with the movable arm in a horizontal position over the beaker, but not contacting the beaker. A rigid immersion wire is fixed to the horizontal arm in a vertical position, for example a 1 mm diameter metal wire. A segment of a web is cut which is small enough to fit inside the beaker without contacting the walls of the beaker, but large enough to provide accurate results, i.e., a segment of about 8 square inches in area. An analytical balance is used to determine its weight, W₁. The cut web segment is fixed on the bottom of the immersion wire by penetrating a portion of the web in the center of the segment, then slowly immersing the web in the water of the beaker without entrapping air bubbles, and without contacting the edges or bottom of the beaker, by moving the height adjustable arm of the stand downward. When the web segment is completely immersed, the height adjustable arm is clamped so that everything is stationary with the web segment completely immersed and not in contact with the beaker nor the top surface of the water. The weight reading on the balance is recorded, which is the buoyancy of the web segment, W₂. If the reading on the balance does not stabilize, the weight after 5 seconds immersion is recorded as the buoyant force, unless the instability is caused by transient surface bubbles which are removed by reimmersion or tapping the beaker sides.

The influence of the wire volume is measured by separately zeroing the balance with the beaker containing immersion fluid on the balance, immersing the wire only to the same depth as during the substrate buoyancy measurement, clamping the wire to the stand, and reading the buoyant force from the wire as the weight on the balance, W₃. W₃ should be small relative to W₂.

The Immersion Density is calculated according to Equation 4:
Immersion Density=[W₁/(W₂−W₃)]×ρ_{f} Equation 4
where ρ_{f} is equal to 1.00 grams per cubic centimeter. Several segments of web are measured until a reliable average result is obtained. For composite materials, the density of a foam component can be measured by removing a portion of the composite and measuring it. Also, the individual component densities of a composite which includes a foam may be algebraically determined by measuring the composite density by the immersion method described herein, and apportioning the weight and volume contribution to the individual components using known or measured basis weight and densities of resins, fibers, or object features of the composite.

### 6. EXAMPLES

### Example 1

A disposable mat comprising 6 sheets is constructed of 5 identical removable sheets and 1 support sheet with an integral ply of polyolefin foam. The sheets are constructed by adhesively laminating a 50 gsm hydroentangled nonwoven to a 19 micron co-extruded film. The nonwoven is manufactured by Ahlstrom Nonwovens in Windsor Locks, Conn. and comprises about 85-90% pulp fiber, 2-10% synthetic fiber such as PET, and 5-10% of a latex binder with colorant added. The nonwoven is aperturedby using a screen in the wet-laid process to reveal a cross-hatch like pattern. The finished nonwoven has apertures that are about 1 mm×2 mm and about 24 apertures/cm². The % open area of the nonwoven is about 45% and the thickness is about 300 microns. The nonwoven is printed with a random pattern using a solvent based ink that will not noticeably rub off when consumer wipes their feet on the surface or bleed when the surface gets wet. The nonwoven is attached to a lower ply co-extruded film by spraying a hot melt adhesive (grade H4073A) from Bostik Findley using a fine spray pattern to maximize surface area and minimize adhesive thickness. The hot melt adhesive is applied at 3.5 grams/meter squared to the film and then the nonwoven is applied on top and the two plies are bonded through a pressure roller. The 19 micron film is coextruded by Filmtech Corp. of Allentown, Pa. and consists of about 50% polypropylene for one layer and 50% of a blend of polyolefin with a thermoplastic elastomer to provide the high coefficient of friction desired for the other layer. The polypropylene layer of the co-extruded film is attached to the nonwoven ply such that the side having a high coefficient of friction is facing outward. The laminated two plies are then cut to 45 cm by 65 cm. A 4-ply support sheet is created by taking a two-ply construction as described above and then adhesive laminating to the water impermeable film, a 2.4 mm thick polypropylene Microfoam MD090 manufactured by Pavek of Chicago, Ill. and also laminating another ply of co-extruded film to the bottom of the foam layer. The foam is adhesively laminated to the film with 5 gsm of Bostik Findley adhesive in the same manner as described above. To make a complete mat, 5 two-ply sheets are stacked on one 4-ply support layer and then die-cut together to the dimensions of 45 cm by 65 cm using a steel rule die. The stack of 6 sheets is then bonded along one 45 cm wide edge using an impulse heat sealer manufactured by Vertrod. The sealing conditions for this example were 60 psi, 12 Volts, 12.5 amps, and 15 seconds seal time with a dwell time of 24 seconds. These impulse sealing conditions result in a seal temperature of approximately 230-270 F. Faster seals of less than 1 second are achievable with alternative sealing methods as described previously. The mat is then rolled up along the sealed edge with the nonwoven side facing outward. The rolling is done with a 2.54 cm diameter dowel that is removed once the mat is rolled up. The rolled up mat is then inserted into a carton having dimensions 3″×3″×18.25″ (7.62 cm×7.62 cm×46.35 cm).

The seal strength between the sheets is measured to be 0.7-1.2 N/cm of seal width. This seal force is easy for the consumer to peel the sheets apart when one sheet gets dirty but sufficient to help keep the sheet together in use. The seal strength of the bond between two sheets is measured with an Instron Tensile Tester from Instron Corporation of Norwood, Mass. with a 2.54 cm gauge length and a crosshead speed of 30.5 cm/min, using the method as described hereinbefore.

The coefficient of friction (CoF) between the support sheet to the floor and sheet to sheet is measured. The CoF between the support sheet and the floor is measured by cutting a 2.5″×3.5″ (6.35 cm×8.89 cm) sample of the 4-ply support sheet and attaching to the bottom of the sled with double sided adhesive tape from 3M. With thicker substrates greater than 0.25 mm, it is recommended that the substrate such as a sheet material is not wrapped around the sled and is instead attached with two-sided tape to the bottom. The 4-ply support sheet is attached to the sled such that the film layer is facing downward and is the surface being tested. A sample of Bruce polyurethane coated Oak hardwood plank, purchased at Home Depot, is cut to 3″×10″ (7.62 cm×25.4 cm) long and is used as the test surface with the polyurethane coated surface facing upward. The 200 gram sled is pulled across the oak plank at 6 inches/minute (15.24 cm/minute) and the initial force to initiate movement is measured as 350 grams and the average kinetic force is measured as 320 grams. Hence the static CoF is 1.75 and the kinetic CoF is 1.6. The CoF against smooth porcelain tiles also purchased at Home Depot is measured, resulting in a static CoF of 3.2 and a kinetic CoF of 3.

The CoF between the sheets is done in the same manner except a sheet having a 2-ply nonwoven, laminated to a high CoF film (as described above), is used on the sled and another identical sheet is layed on the plane of the CoF tester. The sheet attached to the sled is a 6.35 cm×6.35 cm square sample that iss attached to the bottom of the sled with a thin pressure sensitive double sided tape from 3M Corporation. The film side of the 2-ply structure is facing down such that it is the surface being tested. A 5″×10″ (7.62 cm×25.4 cm) piece of 2-ply is taped to the plane of the CoF tester with the nonwoven ply facing upward as the test surface. The sled is then pulled across the test surface per ASTM D1894 and the static and kinetic CoF values are calculated. The static CoF between the sheets is measured to be 1.3 and the kinetic COF is measured to be 1.2.

### Example 2

The kinetic CoF of the support sheet to various floor surfaces is increased by increasing the relative thickness of the co-extruded film. The thickness of the film is increased from 18 micrometers to 20 micrometers and its lower layer is increased from 30% to be 50% of the total film thickness. Further the level of thermoplastic elastomer (TTE) in the lower layer is increased. The higher level of TPE and the increase in the film thickness were expected to increase the kinetic CoF of the support sheet to various floor surfaces. The kinetic CoF is measured using ASTM D1894 of this new support sheet to various standard surfaces. One surface is a 4″×15″ sheet of steel with a 16 finish. The other surface measured is Bruce Hardwood flooring, TF Natural Oak CB921 ¾″ thick×2¼″ A553-233 that is glued and cut to create a 4″×15″ sample. Both the test sheet 40 and the test surfaces are cleaned with Isopropyl alcohol to eliminate possible dust, oil or other components on the film or the surface. The kinetic CoF is measured to be 2-3 for the support sheet to steel and the kinetic CoF of the support sheet to the hardwood floor was measured to vary between 1.5 and 2.5, using a 200 gram sled.

All documents cited in the Detailed Description of the Invention are, in relevant part, incorporated herein by reference; the citation of any document is not to be construed as an admission that it is prior art with respect to the present invention.” To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A disposable mat comprising at least two removable sheets in a stacked configuration and a support sheet, said at least two removable sheets being attached to said support sheet at or adjacent to at least a portion of the perimeter edge of said support sheet, said support sheet providing stiffness, non-slip and cushioning to said at least two removable sheets, wherein said support sheet comprises a foam having a density of from about 0.005 g/cm³ to about 0.5 g/cm³.

2. A disposable mat according to claim 1, wherein said foam has a density of from about 0.008 g/cm³ to about 0.15 g/cm³.

3. A disposable mat according to claim 1, wherein said foam has a rigidity in the Machine Direction from about 0.20 g/cm/cm to about 35.0 g/cm/cm.

4. A disposable mat according to claim 1, wherein said foam is a polyolefin based foam.

5. A disposable mat according to claim 1, wherein said foam comprises at least one slit, at least one corrugation, at least one crease, or combinations thereof.

6. A disposable mat according to claim 5, wherein said disposable mat has 2 short sides and 2 long sides, and wherein said at least one slit, at least one corrugation, or said at least one crease, is parallel to said short sides.

7. A disposable mat according to claim 1, wherein each of said at least two removable sheets and said support sheet each comprise an upper surface and a lower surface, and wherein the kinetic coefficient of friction between the lower surface of the removable sheet which is positioned directly above said support sheet, and the upper surface of said support sheet, is at least about 0.4.

8. A disposable mat according to claim 1, wherein the kinetic coefficient of friction between the lower surface of said support sheet, and a surface on which the disposable mat is placed, is at least about 0.4.

9. A disposable mat according to claim 1, wherein said support sheet comprises an upper ply, a lower ply and an intermediate ply, and wherein said intermediate ply comprises said foam.

10. A disposable mat according to claim 9, wherein said lower ply is water-impermeable.

11. A disposable mat according to claim 9, wherein said lower ply comprises a polyolefin film.

12. A disposable mat according to claim 9, wherein said lower ply comprises a co-extruded film comprising at least layer comprising about 10% of a polyolefin.

13. A disposable mat according to claim 9, wherein said upper ply is absorbent.

14. A disposable mat according to claim 9, wherein said upper ply comprises a nonwoven layer.

15. A disposable mat according to claim 9, wherein said upper ply-is apertured.

16. A disposable mat according to claim 9, wherein said support sheet further comprises an additional ply positioned between said upper ply and said intermediate ply, said additional ply being water-impermeable.

17. A disposable mat according to claim 1, wherein said disposable mat comprises from about 2 to about 15 removable sheets.

18. A disposable mat according to claim 1, wherein said at least 2 removable sheets and said support sheet are attached to each other via thermal bonding, ultrasonic bonding, pressure bonding, embossing, or a combination thereof.

19. A disposable mat according to claim 1, wherein said disposable mat is a domestic floor mat, a car mat, a toilet mat, a bathroom mat, a garage mat, or a mat for absorbing spills.

20. A container comprising at least one disposable mat according to claim 1, rolled-up in a cylindrical configuration.

21. A method of promoting the sale of a disposable mat according to claim 1, said method comprising the step of:
a) displaying a container comprising said disposable mat rolled-up in a cylindrical configuration.
